(19) United States
(12) Patent Application Publication
(10) Pub. No.: US 2013/0137423 A1
(43) Pub. Date: May 30, 2013

(54) ALLOCATING ACCESS TO MULTIPLE RADIO ACCESS TECHNOLOGIES VIA A MULTI-MODE ACCESS POINT

(71) Applicants: Soumya DAS, San Diego, CA (US); Peerapol Tinnakornsrisuphap, San Diego, CA (US)

(72) Inventors: Soumya DAS, San Diego, CA (US); Peerapol Tinnakornsrisuphap, San Diego, CA (US)

(73) Assignee: QUALCOMM Incorporated, San Diego, CA (US)

(21) Appl. No.: 13/480,369

(22) Filed: May 24, 2012

Related U.S. Application Data
(60) Provisional application No. 61/490,714, filed on May 27, 2011.

(51) Int. Cl. H04W 88/10; H04W 76/02

(52) U.S. Cl. CPC H04W 88/10; H04W 76/026
USPC 455/426.1

(57) ABSTRACT

A multi-mode access point supports multiple radio access technologies (e.g., Wi-Fi and cellular) and allocates access to the radio access technologies for various access terminals. To provide improved service for access terminals that are a member of a group associated with the access point, the access point may give priority access to member access terminals as compared to non-member access terminals. For example, the access point may give member access terminals exclusive access to one radio access technology, while giving non-member access terminals access to another (e.g., shared) radio access technology. As another example, the access point may provide a higher level of service for member access terminals on at least one type of radio access technology, while providing a lower level of service for non-member access terminals on the at least one type of radio access technology.

### CLAIM OF PRIORITY

This application claims the benefit of and priority to commonly owned U.S. Provisional Patent Application No. 61/490,714, filed May 27, 2011, and assigned Attorney Docket No. 111682P1, the disclosure of which is hereby incorporated by reference herein.

### BACKGROUND

1. Field

This application relates generally to wireless communication and more specifically, but not exclusively, to allocating access to multiple radio access technologies via a multi-mode access point.

2. Introduction

A wireless communication network may be deployed by an operator over a defined geographical area to provide various types of services (e.g., voice, data, multimedia services, etc.) to users within that geographical area. In a typical implementation, macro access points (also referred to as Node Bs, eNode Bs, etc., each of which corresponds to one or more macrocells) are distributed throughout a network to provide wireless connectivity for access terminals (also referred to as user equipment (UEs), etc., examples of which include cell phones, tablets, entertainment devices, computing devices, and so on) that are operating within the geographical area served by the operator's network.

A macro network deployment is carefully planned, designed and implemented to offer good coverage over the geographical area. Even with such careful planning, however, such a deployment may not completely accommodate channel characteristics such as path loss, fading, multipath, shadowing, etc., in indoor and potentially other environments. Consequently, macrocell users may face coverage issues (e.g., call outages and quality degradation) indoors and at other locations, resulting in poor user experience.

To supplement conventional network access points (e.g., macrocells) and provide enhanced performance, low-power access points may be deployed to provide coverage for access terminals over relatively small coverage areas. For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.).

In various implementations, low-power access points may be referred to as, for example, femtocells, femto access points, home NodeBs, home eNodeBs, access point base stations, picocells, etc. In some implementations, such low-power access points are connected to the Internet and the mobile operator's network via a Digital Subscriber Line (DSL), cable internet access, T1/T3, or some other suitable means of connectivity. In addition, a low-power access point may offer typical access point functionality such as, for example, Base Transceiver Station (BTS) technology, a radio network controller, and gateway support node services.

Some types of access points support multiple modes of operation. For example, a multi-mode access point may provide wireless wide area network (WWAN) service (e.g., cellular service) and at least one other type of wireless service (e.g., Wi-Fi). Such a multi-mode access point may thus provide different wireless services for different access terminals and/or for multi-mode access terminals.

In practice, the configuration of multi-mode systems may be problematic. For examples, users may have to configure policy for the different access modes (technologies) independently. Moreover, users typically need to perform the configuration manually. Also, since different access points are configured and operating independently, this may lead to sub-optimal network operations and user experience. Accordingly, there is a need for more efficient techniques for configuring multi-mode systems.

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to providing coordinated access control for an integrated wireless system that supports different radio access technologies. For example, when users (e.g., access terminals associated with the users) initiate access via one or more types of radio access technology, the wireless system may automatically allocate access for all of the radio access technologies that are commonly supported by the users and the wireless system.

In a typical implementation, such an integrated wireless system comprises a multi-mode access point that supports different radio access technologies (e.g., cellular and Wi-Fi). For example, coordinated access control may be provided in accordance with the teachings herein for a multi-mode access point comprising co-located femtocell and Wi-Fi components. In various embodiments, the different radio access technology components of a multi-mode access point may be physically integrated (e.g., a WWAN access point and a Wi-Fi base station deployed in the same physical housing) or not physically integrated (e.g., a WWAN access point and a Wi-Fi base station deployed in different physical housings and employing some form of inter-device communication).

In some aspects, access to the different types of radio access technologies is allocated in a manner that provides different classes of service to different classes of users (e.g., member users versus non-member users). In this way, the system may ensure, for example, that preferred users receive a desired level of service via the different types of radio access technologies while enabling the system to support lower priority users whenever spare resources are available for such users. In some aspects, the use of an access scheme as taught herein also may improve access terminal transitions between different wireless access modes, thereby improving user experience and improving service continuity. In addition, an access scheme as taught herein may provide a more simplified configuration procedure for multi-mode access points and their served access terminals.

To facilitate such an access control scheme, one or more of the access points may advertise (e.g., via a broadcast message) that the integrated wireless system supports multiple radio access technologies. Also, in the event a particular radio access technology is currently overloaded, this fact may be advertised as well. In this way, an access terminal that supports multiple radio access technologies may more effectively determine whether to attempt access via one or more of the radio access technologies supported by an access point. For example, an access point may throttle service for non-members on any RAT that is overloaded. Consequently, a non-member access terminal may not even attempt to access Wi-Fi via this access point if the Wi-Fi is indicated (e.g., via WWAN signaling) as being overloaded since it is known in this case that the service will be throttled for non-members.

In some embodiments, traffic capacity and demand (e.g. based on the number of members and non-members) in the system is monitored over time. In this way, the classes of service may be dynamically reallocated to ensure that specified criteria (e.g., member service thresholds) are met.

In view of the above, controlling access for a multi-mode access point that supports a first type of radio access technology and a second type of radio access technology involves, in some aspects: determining that at least one member access terminal and at least one non-member access terminal are in communication with the multi-mode access point; and allocating access to the first type of radio access technology and the second type of radio access technology for the at least one member access terminal and the at least one non-member access terminal as a result of the determination.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several aspects of an example of communication system where a multi-mode access point provides service for access terminals;

FIG. 2 is a flowchart of several aspects of an example of operations performed in conjunction with providing coordinated access for different radio access technologies;

FIG. 3 is a flowchart of several aspects of another example of operations performed in conjunction with providing coordinated access for different radio access technologies;

FIG. 4 is a flowchart of several aspects of an example of operations performed in conjunction with reallocating access for different radio access technologies;

FIG. 5 is a simplified block diagram of several sample aspects of components that may be employed in a communication apparatus;

FIG. 6 is a simplified block diagram of several sample aspects of components that may be employed in a multi-mode access point;

FIG. 7 is a simplified diagram of a wireless communication system;

FIG. 8 is a simplified diagram of a wireless communication system including femto nodes;

FIG. 9 is a simplified diagram illustrating coverage areas for wireless communication;

FIG. 10 is a simplified block diagram of several sample aspects of communication components; and

FIG. 11 is a simplified block diagram of several sample aspects of an apparatus configured to support multi-mode communication as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

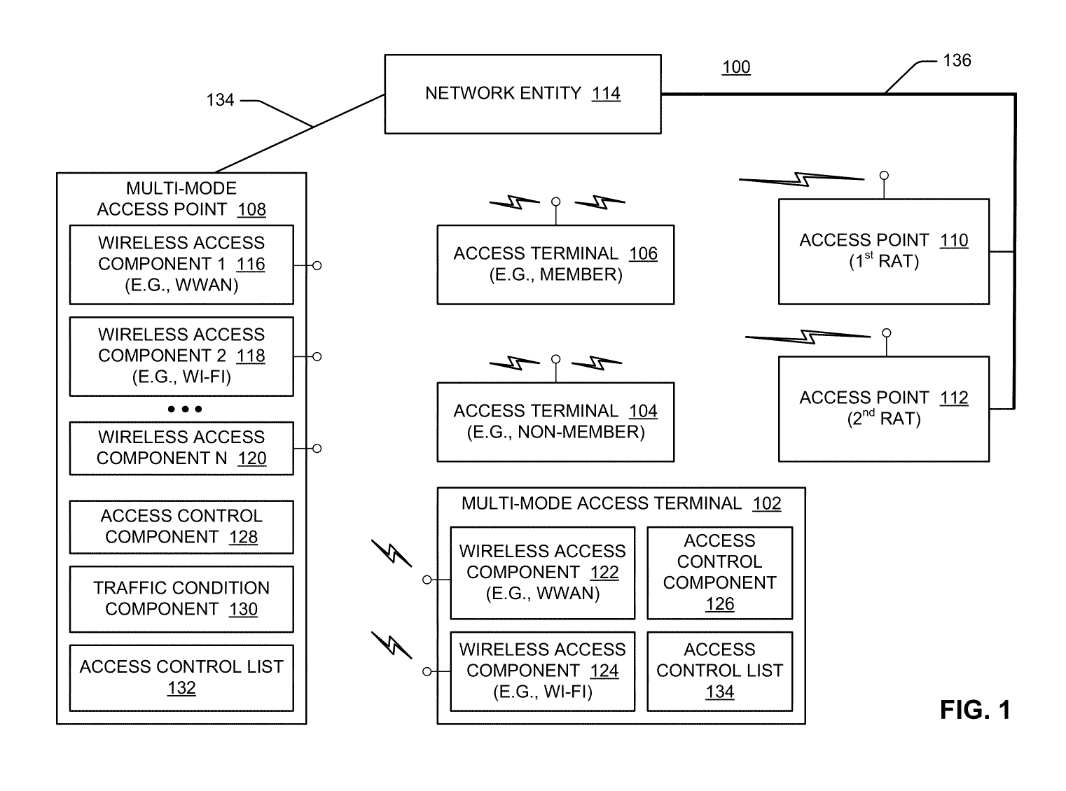

FIG. 1 illustrates several nodes of a sample communication system 100 (e.g., a wireless communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, macrocells, femtocells, and so on, while access terminals may be referred to or implemented as user equipment (UEs), mobiles, and so on.

Access points in the system 100 provide access to one or more services (e.g., network connectivity) for one or more wireless terminals (e.g., access terminals 102, 104, and 106) that may be installed within or that may roam throughout a coverage area of the system 100. For example, at various points in time the access terminal 102 may connect to an access point 108, an access point 110, an access point 112, or some access point in the system 100 (not shown). Similarly, at various points in time the access terminal 104 and/or the access terminal 106 may connect to one these access points.

The access points of the system 100 may employ the same or different radio access technologies (RATs). For example, the access points 110 and 112 may support different RATs. In contrast, the access point 108 may support the RAT supported by the access point 110 and the RAT supported by the access point 112.

As represented in a simplified manner by the lines 134 and 136, each of the access points may communicate over various communication links with one or more network entities (represented, for convenience, by a network entity 114), including each other, to facilitate wide area network (WAN) connectivity. Typically, such a WAN link is referred to as a backhaul link or, simply, the backhaul.

The network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, radio resource management, or some other suitable network functionality. Also, two or more of these network entities may be co-located and/or two or more of these network entities may be distributed throughout a network. Various communication technologies may be employed by a given network entity to communicate with other network entities (e.g., intra-RAT and/or inter-RAT). In addition, the network entities may comprise part circuit-switched network, a packet-switched network, or some other suitable wireless communication network.

Some of the access points (e.g., the access point 108) in the system 100 may comprise low-power access points. A low-power access point will have a maximum transmit power that is less (e.g., by an order of magnitude) than a maximum transmit power of any macro access point in a given coverage area. In some embodiments, low-power access points such as femtocells may have a maximum transmit power of 20 dBm or less. In some embodiments, low-power access points such as picocells may have a maximum transmit power of 24 dBm or less. In contrast, a macrocell may have a maximum transmit power of 43 dBm. It should be appreciated, however, that these or other types of low-power access points may have a higher or lower maximum transmit power in other embodiments. For convenience, low-power access points may be referred to as femtocells or femto access points in the discussion that follows. Thus, it should be appreciated that any discussion related to femtocells or femto access points herein may be equally applicable, in general, to low-power access points or other types of access points.

As mentioned above, the access point 108 supports multi-mode communication. To this end, the access point 108 includes several wireless access components that support different wireless access modes that employ different types of radio access technology (RAT). Specifically, the wireless access component 116 supports a first type of RAT (e.g., WWAN technology), the wireless access component 118 supports a second type of RAT (e.g., wireless local area network (WLAN) technology), and other wireless access components (represented by the wireless access component 120) support up to “N” other types of radio access technologies. Wi-Fi technology is a typical example of WLAN technology. As used herein, the term Wi-Fi technology refers to technology that is based on one or more IEEE 802.11 specifications. In addition, the term WWAN technology refers to technology that provides service over a large geographical area (e.g., several square city blocks or more). Cellular 2G/3G/4G technology (e.g., based on UMTS, LTE, cdma2000, GSM, etc.) is a typical example of WWAN technology.

The access terminals in the system 100 are configured to communicate via one or more of these RATs. Here, some access terminals may support a single mode of communication (e.g., WWAN only) while other access terminals support multi-mode communication. For example, the access terminal 102 includes several wireless access components that support different wireless access modes that employ different RATs. In this example, the wireless access component 122 supports a first type of RAT (e.g., WWAN technology) and the wireless access component 124 supports a second type of RAT (e.g., Wi-Fi technology). The access terminal 102 also includes an access control component 126 that selects one of the radio access technologies for communication with an access point based on a specified criterion or specified criteria. For example, as discussed above, Wi-Fi may be selected whenever Wi-Fi service is detected.

In accordance with the teachings herein, the access point 108 includes an access control component 128 that provides coordinated access control for the different RATs. For example, the access control component 128 may determine which access terminals are allowed to access a given RAT and/or determine the type of service to be provided to a given access terminal on a given RAT.

In some aspects, access to a given RAT is based on whether the access terminal requesting access is a member of a group associated with the access point supporting the RAT. For example, an access point may be associated with one or more closed subscriber groups (CSGs). In addition, one or more access terminals may be associated with (e.g., designated as a member of) a given CSG.

Thus, in some aspects, a member group (e.g., a CSG) defines a limited set of user access terminals that have certain access permissions at a specified set of one or more access points (or cells). To support such access, the access point 108 maintains or otherwise has access to an access control list 132 that identifies the member access terminals (e.g., the access terminals that are members of the CSG(s) associated with the access point 108). In addition, in some implementations, the access terminal 102 maintains an access control list (e.g., a so-called whitelist) that identifies the member group(s) and/or the specific member access point(s) for the access terminal 102.

To this end, an access point may be configured to support different types of access modes. For example, in an open access mode, an access point may allow any access terminal to obtain any type of service via the access point. In contrast, in a restricted (or closed) access mode, an access point may only allow authorized access terminals to obtain service via the access point. For example, an access point may only allow access terminals (e.g., so called home access terminals) belonging to a certain subscriber group (e.g., an associated CSG) to obtain service via the access point.

Furthermore, in a hybrid access mode, alien access terminals (e.g., non-home access terminals, non-CSG access terminals) may only be allowed to obtain access via the access point under certain conditions. For example, a macro access terminal that does not belong to a femtocell's CSG may be allowed to access the femtocell only if the femtocell is not currently serving a home access terminal As another example, a cell operating in hybrid access mode (e.g., a 3GPP hybrid cell) may offer different quality of service (QoS) to member access terminals as compared to non-member access terminals. Similarly, to minimize the impact of non-CSG established communication on CSG members, a wireless network may allow a reduction in a data rate of established packet switched communication for non-CSG members.

In accordance with the teachings herein, coordinated access control is advantageously employed to enhance the user experience of non-member access terminals (e.g., the access terminal 104) without compromising the user experience of member access terminals (e.g., the access terminal 106) in a multi-mode wireless system. In some implementations, an alternate RAT is used to augment service for non-members. Here, if the alternate RAT is not needed for member service, the alternate RAT may be allocated to non-members. As a specific example, a coordinated access control scheme for integrated WWAN and Wi-Fi access modes may be implemented by complementing non-member access terminals with a Wi-Fi (e.g., out of band) link to improve the QoS for these non-members.

In some implementations, coordinated access control involves controlling access to different RATs such that the QoS for members and non-members is satisfied according to defined priorities. For example, member access terminals may be allocated higher QoS (e.g., higher data rates, higher throughput, lower latency, etc.) on a given RAT than non-member access terminals.

Several examples of access policies that may be employed in a system that provides Wi-Fi service and provides 3G and/or 4G cellular service (hereafter referred to as 3G/4G) follow. In a first policy, member access terminals are allocated access over 3G/4G only and non-member access terminals are allocated access over Wi-Fi only. For example, packet switched communication over 3G/4G may be reserved for member access terminals. In a second policy, member access terminals are allocated access over 3G/4G and also Wi-Fi while non-member access terminals are allocated access over Wi-Fi only. In a third policy, member access terminals are allocated access over 3G/4G and also Wi-Fi while non-member access terminals are allocated access over 3G/4G with reduced data rate only. In a fourth policy, member access terminals are allocated access over 3G/4G and also Wi-Fi with higher priority while non-member access terminals are allocated access over 3G/4G with reduced data rate and Wi-Fi with reduced priority.

The manner in which RAT access is provided may be based in some aspects on traffic conditions associated with one or more of the RATs and/or the backhaul. To this end, a traffic condition component 130 may determine and maintain information that is indicative of such traffic conditions. In particular, the traffic condition component 130 may acquire traffic information via wireless communications (e.g., based on signals transmitted by the access terminals and/or the access points of the system 100) and/or based on backhaul communications (e.g., communications over the backhaul link 134).

Several examples of different policies that may be employed under different traffic conditions follow. In one scenario, if WWAN traffic conditions indicate that the WWAN links are heavily utilized, the first policy may be employed to provide the best possible WWAN service for members. Such a policy may be particularly called for if the members generally do not use dual-mode access terminals. Conversely, if members generally do use dual-mode access terminals and if WWAN traffic conditions indicate that the WWAN links are heavily utilized, the second policy may be employed. In another scenario, if Wi-Fi traffic conditions indicate that the Wi-Fi links are heavily utilized, the third policy may be employed to provide the best possible Wi-Fi service for members. In yet another scenario, if WWAN and Wi-Fi traffic conditions indicate that the WWAN and Wi-Fi links are not heavily utilized, the fourth policy may be employed to provide the best possible service for members, while still providing robust service for non-members.

Regarding backhaul traffic conditions, QoS may be improved for non-members as long as a backhaul link for the system is not a bottleneck in network performance. Here, it should be appreciated that if the backhaul is a bottleneck, service for members could be degraded if improved QoS is attempted for non-members on the Wi-Fi link. Hence, in some aspects, an access control decision may be based on traffic conditions on the backhaul.

The policies described above (or any other policies implemented according to the teachings herein) may be employed on a static basis or a dynamic basis. As an example of the former case, upon deployment, an access point may be configured to enforce a given policy. As an example of the latter case, an access point may switch to a different policy as a result of a change in traffic conditions or some other factor (or factors).

It should be appreciated that the above examples are provided for purposes of explanation, and that other configurations may be employed in other implementations in accordance with the teachings herein. For example, a multi-mode access point may support other types of RATs (e.g., FlashLinQ, ultra-wideband (UWB), Bluetooth, and so on). A multi-mode access point may manage access for more than two RATs. In addition, policy selection criteria other than that described herein may be employed in various scenarios in accordance with the teachings herein. A multi-mode access point may manage access for more than two types of users. For example, different classes of members may be defined with different access priorities associated with the different classes.

A multi-mode access point may take different forms in different implementations. In some implementations, a multi-mode access point comprises a single device. For example, the access point 108 may comprise a femtocell that provides WWAN service (e.g., cellular service) and at least one other type of wireless service (e.g., Wi-Fi service). In other implementations, a multi-mode access point comprises a plurality of co-located devices, each of which may support a different type of RAT. For example, one device may provide WWAN service, while at least one other device provides at least one other type of wireless service. It should be appreciated that different combinations of wireless service and/or a different number of devices may be employed in other embodiments consistent with the teachings herein.

In the case where a multi-mode access point comprises co-located devices, it may be desirable for the different devices to provide comparable areas of coverage (e.g., overlapping with respects to the coverage of at least one of the devices). In this way, it may be assured that an access terminal can be switched from one RAT to another. To this end, the co-located devices are located within approximately 2 meters of one another in some implementations.

Co-located devices may communicate with one another via point-to-point communication. For example, point-to-point communication may comprise inter-process communication, local area network subnet communication, or local bus (e.g., USB) communication.

To reduce the complexity of FIG. 1, the components described above are only shown for the access terminal 102 and the access point 108. It should be appreciated, however, that other entities in the system 100 (e.g., the access terminals 104 and 106 and/or the access points 110 and 112) may include one or more similar components.

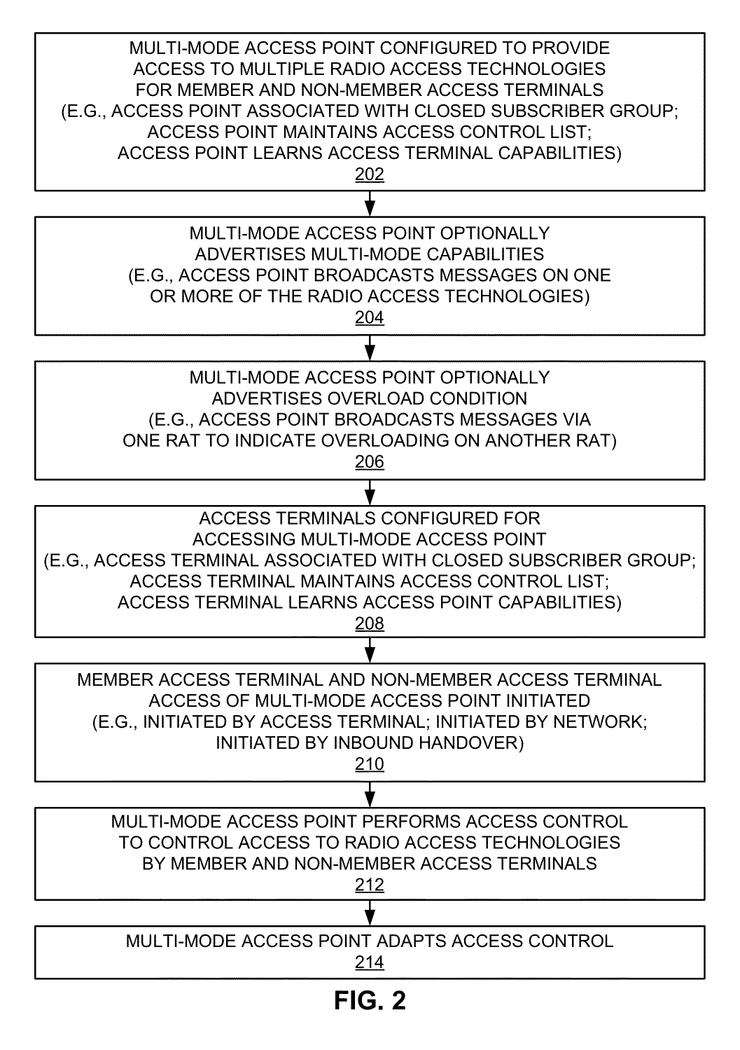

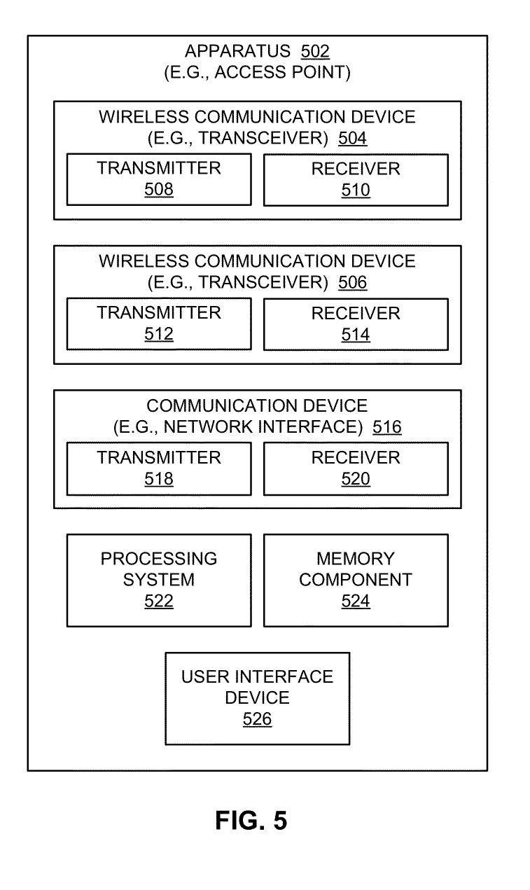

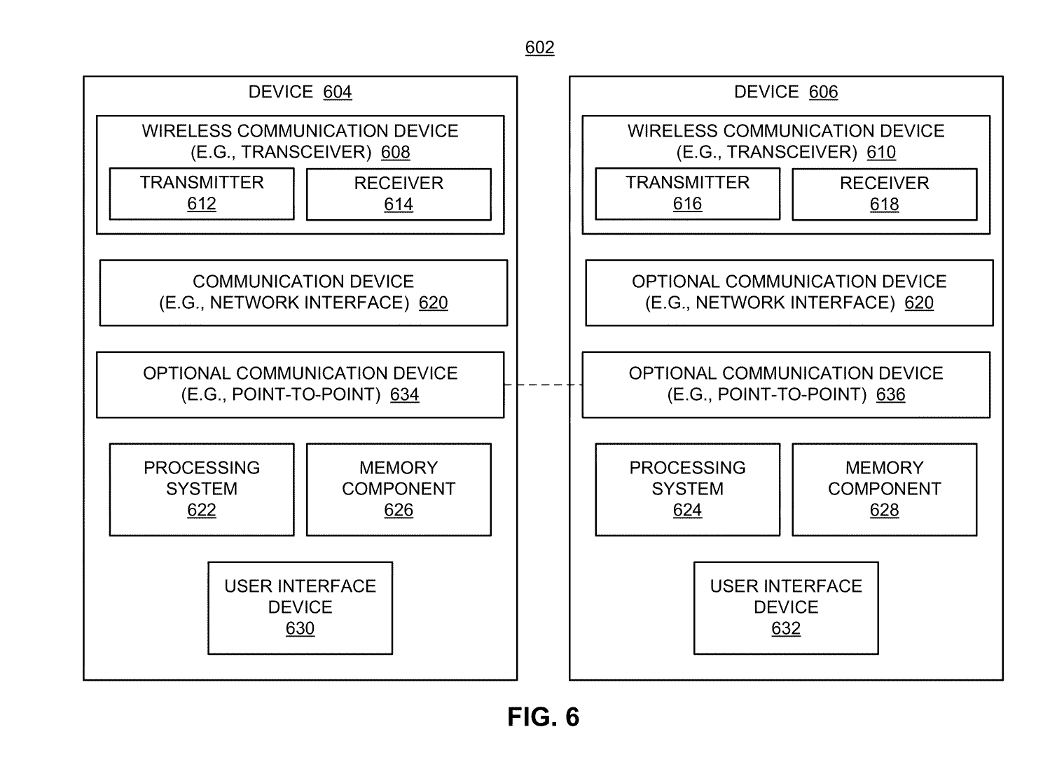

Sample operations that may be employed in accordance with the teachings herein will now be described in more detail in conjunction with the flowcharts of FIGS. 2-4. For convenience, the operations of FIGS. 2-4 (or any other operations discussed or taught herein) may be described as being performed by specific components (e.g., components of FIG. 1, FIG. 5, FIG. 6, etc.). It should be appreciated, however, that these operations may be performed by other types of components and may be performed using a different number of components. It also should be appreciated that one or more of the operations described herein may not be employed in a given implementation.

Referring initially to FIG. 2, this flowchart illustrates an overview of operations that may be employed in an implementation based on the teachings herein. In particular, these operations relate to configuring a multi-mode access point for multi-mode operation, configuring access terminals for accessing such an access point, to performing coordinated multi-RAT access control.

As represented by block 202, the multi-mode access point is configured to provide access to multiple radio access technologies for member and non-member access terminals. Typically, some of these configuration operations are performed upon deployment of the access point, while other configuration operations are performed during subsequent access point operation (e.g., when access terminals communicate with the access point).

In some implementations, the operations of block 202 involve associating the access point with a member group. For example, a user of the access point may register the access point with the network to associate the access point with one or more CSGs. Typically, this involves communicating with an appropriate management entity of an operator's network to have the access point join (e.g., become a member of) the CSG.

In conjunction with establishing membership with a group, the access point will maintain an access control list in some cases. For example, upon joining a CSG, the network may send a list of the current CSG member access terminals to the access point. As another example, the access point may subsequently learn about additional member access terminals when those access terminal communicate with (e.g., register with) the access point.

The access point also may learn various capabilities of member access terminals and/or non-member access terminals over time. For example, at some point in time, a multi-mode access terminal may enter a coverage area of a multi-mode access point and initiate communication with the access point (e.g., on a cellular channel). At this time, the access point and the access terminal may learn the capabilities of one another. Thus, each device will detect the multi-mode property and other properties of the other device.

In addition, the access point may learn various relationships of member access terminals and/or non-member access terminals over time. For example, an access point may learn a relationship between an IEEE 802 media access control (MAC) identifier (ID) of an access terminal and an international mobile subscriber identity (IMSI), a mobile subscriber integrated services digital network (MSISDN), an international mobile equipment identity (IMEI), or an electronic serial number (ESN) of the access terminal by interfacing with an application on the access terminal or by learning this information in some other way (e.g., based on network information acquired over time). For example, when the access terminal registers with the access point, the access point may acquire the MAC ID of the access terminal along with the IP address that will be used for a Wi-Fi access mode. Thus, in some aspects, the operations of block 202 involve associating (e.g., matching) configuration information for the different types of RATs. Consequently, a single operation, rather than separate operations, may be used to configure the access point's multiple RAT components (e.g., a femtocell and a Wi-Fi access point).

In some implementations, an access point supports tiered services in Wi-Fi access mode. For example, a Wi-Fi access point component of a multi-mode access points may advertise multiple service set identifiers (SSIDs) and provide better services on some SSIDs (e.g., for home users or owners) than other SSIDs (e.g., for guests or children of the user). An SSID that is reserved for a member in the access control list may not be advertised or may require authentication. Such authentication may be provided, for example, through the use of Wi-Fi Protected Access (WPA) or Extensible Authentication Protocol-Subscriber Identity Module (EAP-SIM). Conversely, an SSID for non-member access may be open.

It is typically desired that a given configuration works consistently for the different access modes (e.g., both femtocell and Wi-Fi access modes). For example, a MAC identity restriction or policy can be configured to match with a femtocell ACL. Thus, a particular access terminal that is restricted in a given manner for Wi-Fi service may be restricted in a similar manner for cellular service. Similar restrictions or policies may be employed for MAC address filtering and the femtocell ACL. That is, an access point's ACL also may include the MAC address information for the listed access terminals. The access point may thus use the ACL to identify an access terminal for which Wi-Fi access is to be restricted based on the MAC address provided by the access terminal (e.g., when the access terminal attempts to register at the access point) in a similar manner as the access point uses the ACL to identify an access terminal for which cellular access is to be restricted based on the corresponding identifier (e.g., IMSI, etc.) provided by the access terminal. As another example, a user data rate may be throttled for any MAC IDs associated with non-members in the femtocell ACL. Thus, non-members may be throttled in a consistent manner for both Wi-Fi service and cellular service.

As represented by block 204, in some implementations, the access point advertises its multi-mode capabilities. For example, the access point may convey Wi-Fi details including the version being supported (e.g., 802.11b, 802.11g, 802.11n, etc.), the channel of operation, and MIMO support for easier Wi-Fi detection, etc.

The access point may advertise these capabilities by broadcasting messages via one or more of the RATs supported by the access point. In some implementations (e.g., a UMTS-based system), the access point advertises its capability via WWAN signaling in a master information block (MIB). In some implementations (e.g., an LTE-based system), the access point advertises its capability via WWAN signaling in a subscriber information block (SIB).

As represented by block 206, in some implementations, the access point advertises an overload condition via a RAT (e.g., by generating an overload indicator for the RAT that is transmitted on that RAT and/or another RAT). For example, since Wi-Fi operates in unlicensed radio spectrum, Wi-Fi communication is subject to in-home interferers as well as neighborhood interferers. However, an access point may have visibility to various Wi-Fi-related factors including throughput, interference, the number of active devices, backhaul utilization, and so on. Consequently, in accordance with the teachings herein, an access point may advertise a Wi-Fi overload indicator (e.g., via a WWAN broadcast message) if the access point determines that the Wi-Fi access mode is congested due to interference and/or a large number of devices accessing Wi-Fi (and if the backhaul is not the network bottleneck). During periods of interference such as this, hybrid cells may revoke additional Wi-Fi QoS privileges to non-member access terminals. Conversely, when an overload condition does not exist, the access point may stop advertising the Wi-Fi overload indicator and start provisioning additional Wi-Fi QoS privileges to non-member access terminals.

As represented by block 208, at least one access terminal is configured for accessing the multi-mode access point. Typically, some of these configuration operations are performed upon deployment of the access terminal, while other configuration operations are performed during subsequent access terminal operation (e.g., when the access terminal communicates with access points). To enable the configuration operations discussed herein, each access terminal implements an appropriate application and functionality for establishing communication between the application and the access point or a provisioning server in the network. For example, the application may determine whether the access terminal is communicating with a multi-mode access point that supports multi-RAT access allocation or some other type of access point. For example, the application may make this determination based on broadcast messages received by the access terminal as discussed herein, based on detection of signals from multiple RATs at the access terminal, or based on some other information. In the event a multi-mode access point is indicated, the application may negotiate with the multi-mode access point or the provisioning server to invoke multi-RAT access allocation.

In some implementations, the operations of block 208 involve associating an access terminal with a particular member group. For example, a user of the access terminal may register the access terminal with the network to cause the access terminal to belong to one or more CSGs associated with the access point. Typically, this involves communicating with an appropriate management entity of an operator's network to have the access terminal join (e.g., become a member of) the CSG.

In conjunction with establishing membership with a group, the access terminal may maintain a list of accessible groups (e.g., a whitelist of CSGs that are allowed). For example, upon joining a CSG, the network may send a list of the current CSG member access points to the access terminal. As another example, the access terminal may subsequently learn about additional member access points when the access terminal communicates with (e.g., registers with) those access points.

To provide more streamlined access terminal access control configuration, the act of adding an access terminal to an access control list (e.g., a femtocell access control list) may result in the access terminal being automatically configured with the appropriate information for communicating on a given RAT. For example, upon adding the access terminal to an access control list (ACL) for a given femtocell, the access terminal may be automatically configured with the Wi-Fi service set identifier (SSID) and security keys to be used to access Wi-Fi via that femtocell.

The access terminal also may learn various capabilities of access points over time. As discussed above, an access terminal may enter a coverage area of a multi-mode access point and initiate communication with the access point (e.g., on a cellular channel) and learn the capabilities of the access point at that time.

For example, upon determining that an access point supports local Internet Protocol access (LIPA), the access terminal may be configured to use such access when connected to the access point. A legacy access terminal (e.g., a handset) may support LIPA by manually configuring an access point name (APN) and then enabling the access when appropriate. In another scenario, an application may support LIPA when a user is connected on a femtocell system. In this case, the application may check a cell identifier (CELL ID) of an access point to which the access terminal is connected to determine whether the access point is a femtocell (e.g., associated with a given CSG). If so, the access terminal may be configured for LIPA via that femtocell.

In some implementations, an access terminal adapts the manner in which it initiates access based on one or more factors. For example, an access terminal may leave its Wi-Fi transceiver in a low power mode (e.g., turned off) until the access terminal determines that it is within Wi-Fi coverage.

In practice, Wi-Fi communication may adversely impact access terminal battery consumption. Consequently, an access terminal may either turn Wi-Fi mode off or the access terminal may employ less aggressive Wi-Fi scanning to limit power consumption. Such techniques may be employed because the access terminal may still be able to determine whether it is within the Wi-Fi coverage of a multi-mode access point upon receiving the capability advertisement from the access point.

In the event there is a need for high data rate service (e.g., a user invokes a video streaming application), the access terminal may activate Wi-Fi mode and scan aggressively for Wi-Fi service. The access terminal may send probe requests aggressively over Wi-Fi mode to figure out if the access point responds and whether the Wi-Fi received signal strength indication (RSSI) is sufficient. This feature may help the access terminal in quickly acquiring or reacquiring an IP address over Wi-Fi.

As represented by block 210, at some point in time, member access terminals and non-member access terminals initiate access with the access point. Such access may be initiated in various ways. For idle handover (e.g., reselection from macrocell to femtocell), access is initiated by either the access terminal or the network once the access terminal enters the coverage of the access point. Alternatively, access may be initiated during inbound active handover (e.g., from macrocell to femtocell).

As represented by block 212, the access point performs coordinated access control to control access to different RATs for the member and non-member access terminals. For example, as discussed herein, these operations may involve restricting access to certain RATs to members and/or enforcing different restrictions on services provided via a RAT to member and non-members. In addition, these operations may be implemented during access terminal or network initiated access or during inbound handover as discussed above.

As represented by block 214, in some implementations, the access point adapts the access control scheme over time. For example, the access point may elect to use a different access control policy as discussed herein. In some cases, the operations of block 214 may involve adapting the service (e.g., raising or lowering QoS) provided for a given type of access terminal on a given RAT.

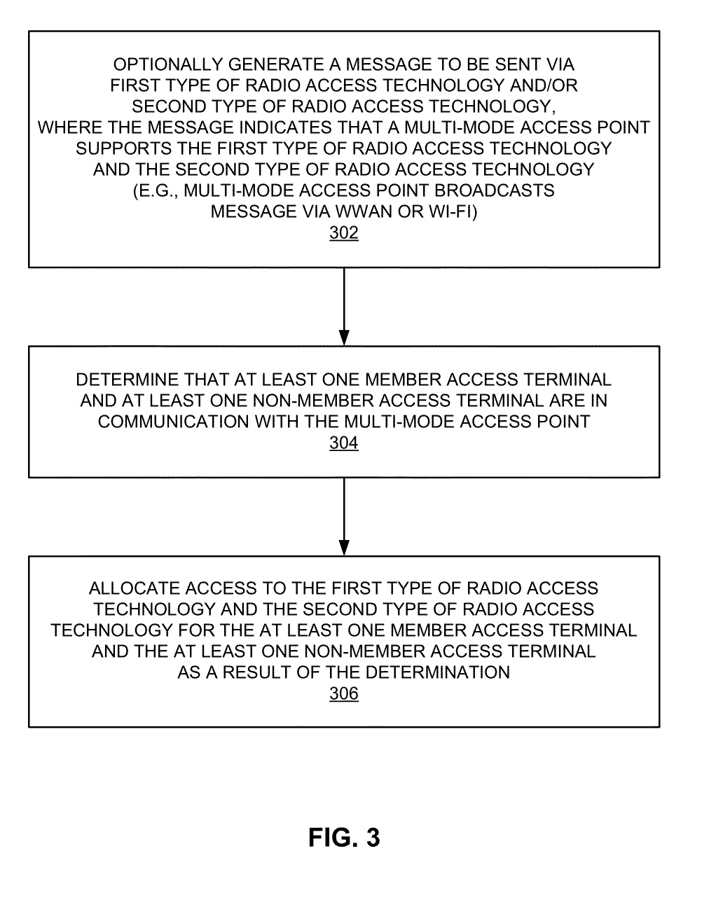

Referring now to FIG. 3, this flowchart describes an example of a coordinated access scheme. For purposes of illustration, these operations are described in the context of a multi-mode access point that supports two RATs. It should be appreciated, however, that the disclosed operations may be applicable to other types of multi-mode access points.

As represented by block 302, in some implementations, the access point generates a message to be sent via the first type of radio access technology and/or the second type of radio access technology, where the message indicates that the multi-mode access point supports the first type of radio access technology and the second type of radio access technology. For example, an integrated femtocell-Wi-Fi access point may broadcast a message indicating that the access point provides both femtocell service and Wi-Fi service. In various embodiments, this message may be sent via cellular signaling, Wi-Fi signaling, or both cellular signaling and Wi-Fi signaling.

As represented by block 304, at some point in time, a determination is made as to whether at least one member access terminal and at least one non-member access terminal are in communication with the multi-mode access point. The determination of block 304 may be made in various ways. For example, the access point may receive registration messages or some other type of messages from these access terminals. As another example, the access point may receive handover messages or redirection messages relating to active handover or idle handover of these access terminals.

As discussed herein, membership may be associated with one or more closed subscriber groups. For example, the at least one member access terminal may belong to a closed subscriber group associated with the multi-mode access point, while the at least one non-member access terminal does not belong to any closed subscriber group associated with the multi-mode access point.

Also as discussed herein, the different RATs may take various forms. For example, in a typical implementation, the first type of radio access technology comprises wireless wide area network technology and the second type of radio access technology comprises Wi-Fi technology.

Also, in some implementations, the multi-mode access point comprises co-located access points (e.g., co-located femtocell and Wi-Fi access points). In some implementations, the multi-mode access point comprises co-located first and second access points that are deployed within a common apparatus or are deployed within separate apparatuses that are located within 2 meters of one another. In some implementations, the first access point and the second access point communicate with one another via point-to-point communication. In some implementations, the point-to-point communication comprises: inter-process communication, local area network subnet communication, or local bus communication.

As represented by block 306, as a result of the determination of block 304, access to the first type of radio access technology and the second type of radio access technology is allocated for the at least one member access terminal and the at least one non-member access terminal. In some aspects, the allocation of access gives priority to the at least one member access terminal over the at least one non-member access terminal. For example, as discussed herein, non-member access terminals may be restricted from accessing certain RATs or non-member access terminals may receive restricted service on certain RATs.

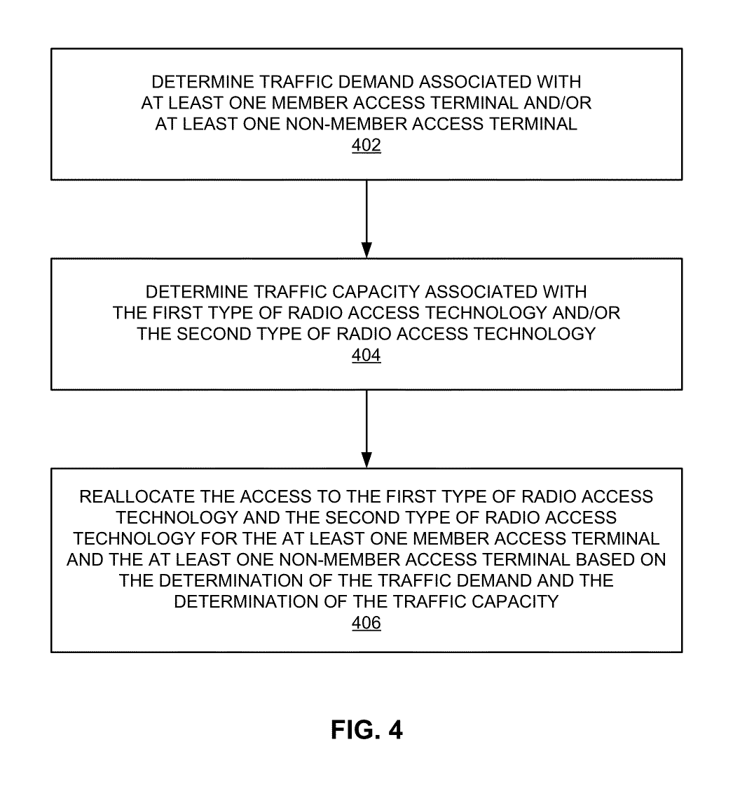

The flowchart of FIG. 4 describes various operations that may be performed in conjunction with reallocating access at a multi-mode access point based on traffic conditions.

As represented by block 402, a determination is made of the traffic demand associated with the at least one member access terminal and/or the at least one non-member access terminal. For example, the multi-mode access point may determine the throughput, latency, data rate, the number of active member users, the number of active non-member users, or a combination of these or other metrics indicative of the demand from the access terminals. Such a determination may be made, for example, by monitoring traffic flows for each of the access terminals.

As represented by block 404, a determination is made of the traffic capacity associated with the first type of radio access technology and/or the second type of radio access technology. For example, the multi-mode access point may determine the throughput, latency, data rate, some other capacity metric, or a combination of these metrics that is achievable on each of the RATs supported by the access point. Such a determination may be made, for example, by measuring interference, traffic flow, error rates, etc., on each of the RATs.

As represented by block 406, based on the determination of the traffic demand at block 402 and the determination of the traffic capacity at block 404, there is a reallocation of the access to the first type of radio access technology and the second type of radio access technology for the at least one member access terminal and the at least one non-member access terminal. For example, as discussed herein, resources may be reallocated to member access terminals in the event these access terminals are not obtaining adequate QoS.

In some implementations, coordinated access control for a multi-mode access point involves determining whether to revoke access based on congestion in the system. For example, the multi-mode access point may comprise a first access point that support a first type of RAT and a second access point that supports a second type of RAT as discussed herein. In one example, the first access point is a femtocell access point and the second access point is a Wi-Fi access point. A member access terminal is granted a first access to the first access point. In addition, a non-member access terminal is granted a second access to the second access point without interruption to the first access point. The congestion level of the second access point (e.g., the Wi-Fi access point) is then monitored. If the congestion level exceeds a threshold, the allowed second access to the second access point (e.g., the Wi-Fi access point) is revoked. One skilled in the art would understand that the value of the threshold may depend on one or more factors including, for example but not limited to, user choice, system application, design consideration, etc., without affecting the spirit or scope of the present disclosure.

FIG. 5 illustrates several sample components (represented by corresponding blocks) that may be incorporated into an apparatus 502 (e.g., corresponding to the access point 108 of FIG. 1) to perform multi-mode operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other nodes in a system may include components similar to those described for the apparatus 502 to provide similar functionality. Also, a given node may contain one or more of the described components.

As shown in FIG. 5, the apparatus 502 includes a plurality of wireless communication devices (e.g., transceivers) for communicating with other nodes (e.g., access terminals) via different radio access technologies. In the example of FIG. 5, the apparatus 502 is depicted as including two wireless communication devices 504 and 506. It should be appreciated, however, that different numbers of wireless communication devices (e.g., three, four, or more) may be deployed in different embodiments. Also, a given communication device may comprise one transceiver or more than one transceiver (e.g., for communicating on different carrier frequencies). The wireless communication device 504 includes at least one transmitter 508 for sending signals (e.g., messages, information) and at least one receiver 510 for receiving signals (e.g., messages, information). Similarly, the wireless communication device 506 includes at least one transmitter 512 for sending signals (e.g., messages, information) and at least one receiver 514 for receiving signals (e.g., messages, information). In some embodiments, a wireless communication device (e.g., one of multiple wireless communication devices of the apparatus 502) comprises a network listen module that may be used, for example, to monitor uplink traffic.

The apparatus 502 includes at least one communication device 516 (e.g., a network interface) for communicating with other nodes. For example, the communication device 516 may be configured to communicate with one or more network entities via a wire-based or wireless backhaul. In some aspects, the communication device 516 may be implemented as a transceiver configured to support wire-based or wireless signal communication. This communication may involve, for example, sending and receiving: messages, parameters, other types of information, and so on. Accordingly, in the example of FIG. 5, the communication device 516 is shown as including a transmitter 518 and a receiver 520.

The apparatus 502 also includes other components that may be used in conjunction with multi-mode operations as taught herein. For example, the apparatus 502 includes a processing system 522 for providing functionality relating to access allocation (e.g., determine that member and non-member access terminals are in communication with a multi-mode access point, allocate access to the first and second types of radio access technology, determine traffic demand, determine traffic capacity, reallocate access to the first and second types of radio access technology, generate a message that indicates that the multi-mode access point supports the first and second types of radio access technology, and so on) and for providing other processing functionality. The apparatus 502 includes a memory component 524 (e.g., including a memory device) for maintaining information (e.g., traffic information, thresholds, parameters, and so on). In addition, the apparatus 502 includes a user interface device 526 for providing indications (e.g., audible and/or visual indications) to a user and/or for receiving user input (e.g., upon user actuation of a sensing device such a keypad, a touch screen, a microphone, and so on).

For convenience the apparatus 502 is shown in FIG. 5 as including components that may be used in the various examples described herein. In practice, the illustrated blocks may have different functionality in different implementations. For example, the functionality of the block 522 may be different in an embodiment where reallocation involves adjusting QoS as compared to an embodiment where reallocation involves revoking access.

The components of FIG. 5 may be implemented in various ways. In some implementations the components of FIG. 5 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some or all of the functionality represented by blocks 504, 506, 516, 522, 524, and 526 may be implemented by a processor or processors of an apparatus and data memory of the apparatus (e.g., by execution of appropriate code and/or by appropriate configuration of processor components).

As mentioned above, in some embodiments, an access point comprises a plurality of co-located components that are not implemented in a common (i.e., the same) device. FIG. 6 illustrates several sample components (represented by corresponding blocks) that may be incorporated into a multi-mode access point 602 (e.g., corresponding to the access point 108 of FIG. 1) that employs multiple devices (e.g., embodied in different housings). That is, FIG. 6 illustrates an example of an implementation where different RAT components are not physically integrated (e.g., a WWAN access point and a Wi-Fi base station deployed in different physical housings and employing some form of inter-device communication). It should be appreciated that these components may be implemented in different types of apparatuses in different implementations (e.g., in different ASICs, in different SoCs, etc.). The described components also may be incorporated into other nodes in a communication system. Also, a given node may contain one or more of the described components.

As shown in FIG. 6, the access point 602 includes a plurality of devices. In this example, the access point 602 is depicted as including two devices 604 and 606. It should be appreciated, however, that different numbers of devices (e.g., three, four, or more) may be deployed in different embodiments.

Each of the devices 604 and 606 includes at least one wireless communication device (e.g., transceiver) for communicating with other nodes via a designated radio access technology. In the example of FIG. 6, the device 604 includes a wireless communication device 608 and the device 606 includes a wireless communication device 610. Thus, the access point 602 includes two wireless communication devices in this example. It should be appreciated, however, that different numbers of wireless communication devices (e.g., three, four, or more) may be deployed in different embodiments.

In a typical implementation, the different devices 604 and 606 comprise components (e.g., access points or base stations) for different types of RATs. For example, in a sample implementation, the wireless communication device 608 comprises a femtocell and the wireless communication device 610 comprises a Wi-Fi base station.

A given wireless communication device may comprise one transceiver or more than one transceiver (e.g., for communicating on different carrier frequencies). The wireless communication device 608 includes at least one transmitter 612 for sending signals (e.g., messages, information) and at least one receiver 614 for receiving signals (e.g., messages, information). Similarly, the wireless communication device 610 includes at least one transmitter 616 for sending signals (e.g., messages, information) and at least one receiver 618 for receiving signals (e.g., messages, information). As discussed above, in some implementations, a wireless communication device comprises a network listen module.

The access point 602 includes at least one communication device 620 (e.g., a network interface) for communicating with other nodes (e.g., network entities). In some implementations, the access point 602 includes a single communication device 620 (e.g., in the device 604). In this case, the access point may use a single backhaul link to communicate with a WAN (e.g., via a core network). In other implementations, the access point 602 includes multiple communication devices 620 (e.g., one each in the devices 604 and 606). In this case, the access point 602 may use multiple backhaul links to communicate with a WAN.

The communication device 620 may be configured to communicate with one or more network entities via a wire-based or wireless backhaul. In some aspects, the communication device 620 may be implemented as a transceiver (e.g., including transmitter and receiver components) configured to support wire-based or wireless signal communication as discussed above in conjunction with FIG. 5.

The devices 604 and 606 may include communication devices 634 and 636, respectively, for providing point-to-point communication. For example, the communication devices may provide interfaces to a local bus (e.g., USB) over which the devices 604 and 606 communicate (e.g., to coordinate access allocation between RATs). As another example, the communication devices may provide interfaces for wireless communication (e.g., via UWB, Bluetooth, etc.) between the devices 604 and 606.

The devices 604 and 606 also include other components that may be used in conjunction with multi-mode operations as taught herein. For example, the device 604 includes a processing system 622 for providing functionality relating to allocating access (e.g., as discussed above in conjunction with FIG. 5), supporting the corresponding RAT for the device 604, and providing other processing functionality. The device 606 also includes a processing system 624 for providing functionality relating to controlling multi-mode operations (e.g., as discussed above in conjunction with FIG. 5), supporting the corresponding RAT for the device 606, and providing other processing functionality. The devices 604 and 606 include memory components 626 and 628 (e.g., each including at least one memory device), respectively, for maintaining information (e.g., traffic information, thresholds, parameters, and so on). In addition, the devices 604 and 606 include user interface devices 630 and 632, respectively, for providing indications (e.g., audible and/or visual indications) to a user and/or for receiving user input (e.g., upon user actuation of a sensing device such a keypad, a touch screen, a microphone, and so on).

The components of FIG. 6 may be implemented in various ways. In some implementations the components of FIG. 6 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some or all of the functionality represented for a given device may be implemented by a processor or processors of the device and data memory of the device (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macro cell, and so on. Also, a femto access point may be configured or referred to as a Home NodeB, Home eNodeB, access point base station, femtocell, and so on. In some implementations, a node may be associated with (e.g., referred to as or divided into) one or more cells or sectors. A cell or sector associated with a macro access point, a femto access point, or a pico access point may be referred to as a macro cell, a femtocell, or a pico cell, respectively.

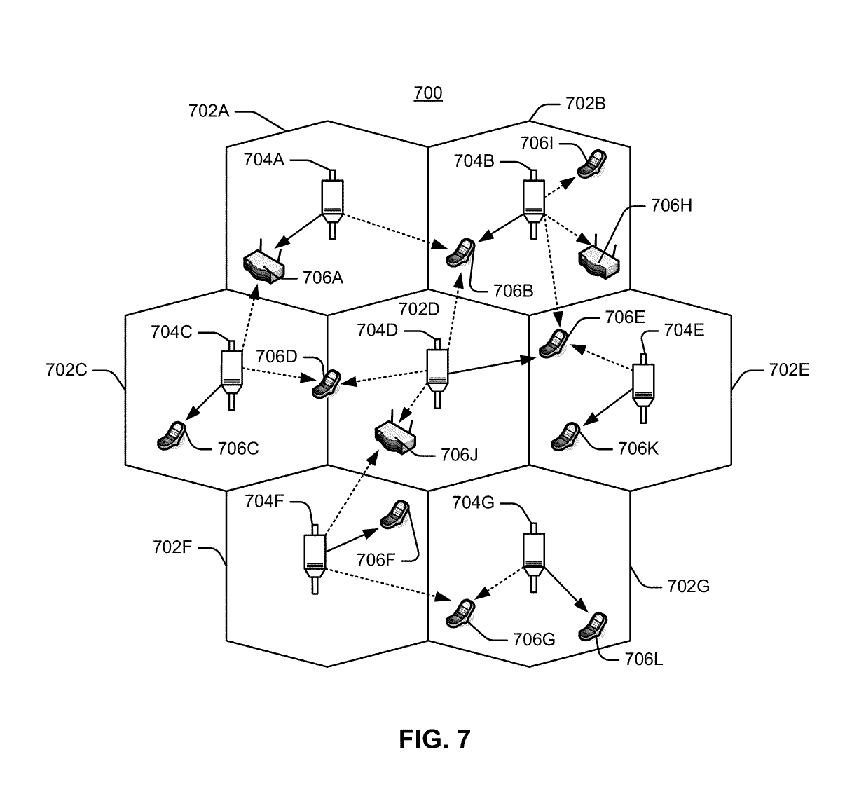

FIG. 7 illustrates a wireless communication system 700, configured to support a number of users, in which the teachings herein may be implemented. The system 700 provides communication for multiple cells 702, such as, for example, macro cells 702A-702G, with each cell being serviced by a corresponding access point 704 (e.g., access points 704A-704G). As shown in FIG. 7, access terminals 706 (e.g., access terminals 706A-706L) may be dispersed at various locations throughout the system over time. Each access terminal 706 may communicate with one or more access points 704 on a forward link (FL) and/or a reverse link (RL) at a given moment, depending upon whether the access terminal 706 is active and whether it is in soft handoff, for example. The wireless communication system 700 may provide service over a large geographic region. For example, macro cells 702A-702G may cover a few blocks in a neighborhood or several miles in a rural environment.

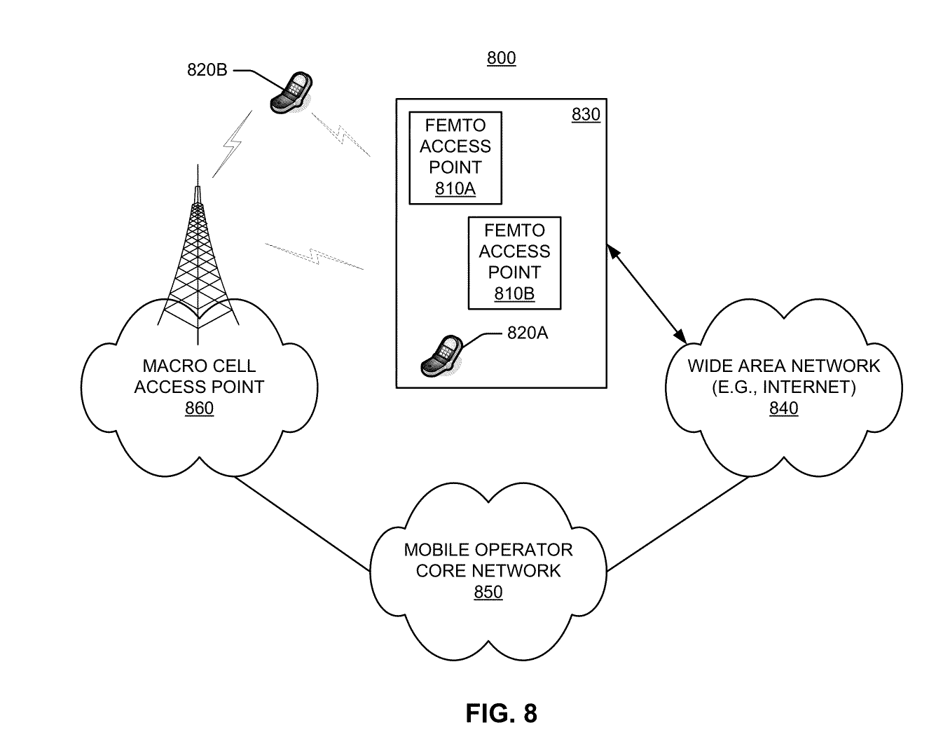

FIG. 8 illustrates an exemplary communication system 800 where one or more femto access points are deployed within a network environment. Specifically, the system 800 includes multiple femto access points 810 (e.g., femto access points 810A and 810B) installed in a relatively small scale network environment (e.g., in one or more user residences 830). Each femto access point 810 may be coupled to a wide area network 840 (e.g., the Internet) and a mobile operator core network 850 via a DSL router, a cable modem, a wireless link, or other connectivity means (not shown). As will be discussed below, each femto access point 810 may be configured to serve associated access terminals 820 (e.g., access terminal 820A) and, optionally, other (e.g., hybrid or alien) access terminals 820 (e.g., access terminal 820B). In other words, access to femto access points 810 may be restricted whereby a given access terminal 820 may be served by a set of designated (e.g., home) femto access point(s) 810 but may not be served by any non-designated femto access points 810 (e.g., a neighbor's femto access point 810).

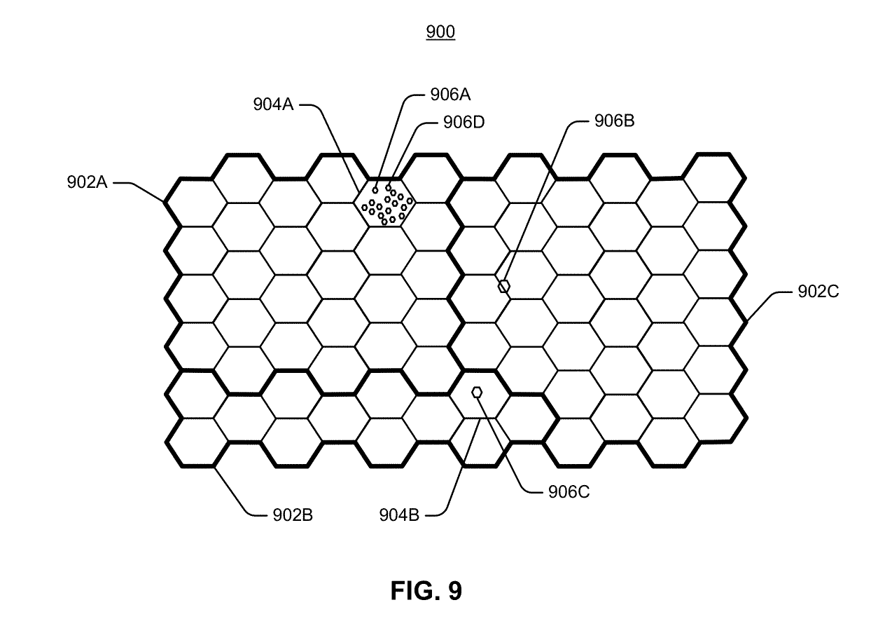

FIG. 9 illustrates an example of a coverage map 900 where several tracking areas 902 (or routing areas or location areas) are defined, each of which includes several macro coverage areas 904. Here, areas of coverage associated with tracking areas 902A, 902B, and 902C are delineated by the wide lines and the macro coverage areas 904 are represented by the larger hexagons. The tracking areas 902 also include femto coverage areas 906. In this example, each of the femto coverage areas 906 (e.g., femto coverage areas 906B and 906C) is depicted within one or more macro coverage areas 904 (e.g., macro coverage areas 904A and 904B). It should be appreciated, however, that some or all of a femto coverage area 906 may not lie within a macro coverage area 904. In practice, a large number of femto coverage areas 906 (e.g., femto coverage areas 906A and 906D) may be defined within a given tracking area 902 or macro coverage area 904. Also, one or more pico coverage areas (not shown) may be defined within a given tracking area 902 or macro coverage area 904.

Referring again to FIG. 8, the owner of a femto access point 810 may subscribe to mobile service, such as, for example, 3G mobile service, offered through the mobile operator core network 850. In addition, an access terminal 820 may be capable of operating both in macro environments and in smaller scale (e.g., residential) network environments. In other words, depending on the current location of the access terminal 820, the access terminal 820 may be served by a macro cell access point 860 associated with the mobile operator core network 850 or by any one of a set of femto access points 810 (e.g., the femto access points 810A and 810B that reside within a corresponding user residence 830). For example, when a subscriber is outside his home, he is served by a standard macro access point (e.g., access point 860) and when the subscriber is at home, he is served by a femto access point (e.g., access point 810A). Here, a femto access point 810 may be backward compatible with legacy access terminals 820.

A femto access point 810 may be deployed on a single frequency or, in the alternative, on multiple frequencies. Depending on the particular configuration, the single frequency or one or more of the multiple frequencies may overlap with one or more frequencies used by a macro access point (e.g., access point 860).

In some aspects, an access terminal 820 may be configured to connect to a preferred femto access point (e.g., the home femto access point of the access terminal 820) whenever such connectivity is possible. For example, whenever the access terminal 820A is within the user's residence 830, it may be desired that the access terminal 820A communicate only with the home femto access point 810A or 810B.

In some aspects, if the access terminal 820 operates within the macro cellular network 850 but is not residing on its most preferred network (e.g., as defined in a preferred roaming list), the access terminal 820 may continue to search for the most preferred network (e.g., the preferred femto access point 810) using a better system reselection (BSR) procedure, which may involve a periodic scanning of available systems to determine whether better systems are currently available and subsequently acquire such preferred systems. The access terminal 820 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 810, the access terminal 820 selects the femto access point 810 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 810 that reside within the corresponding user residence 830). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

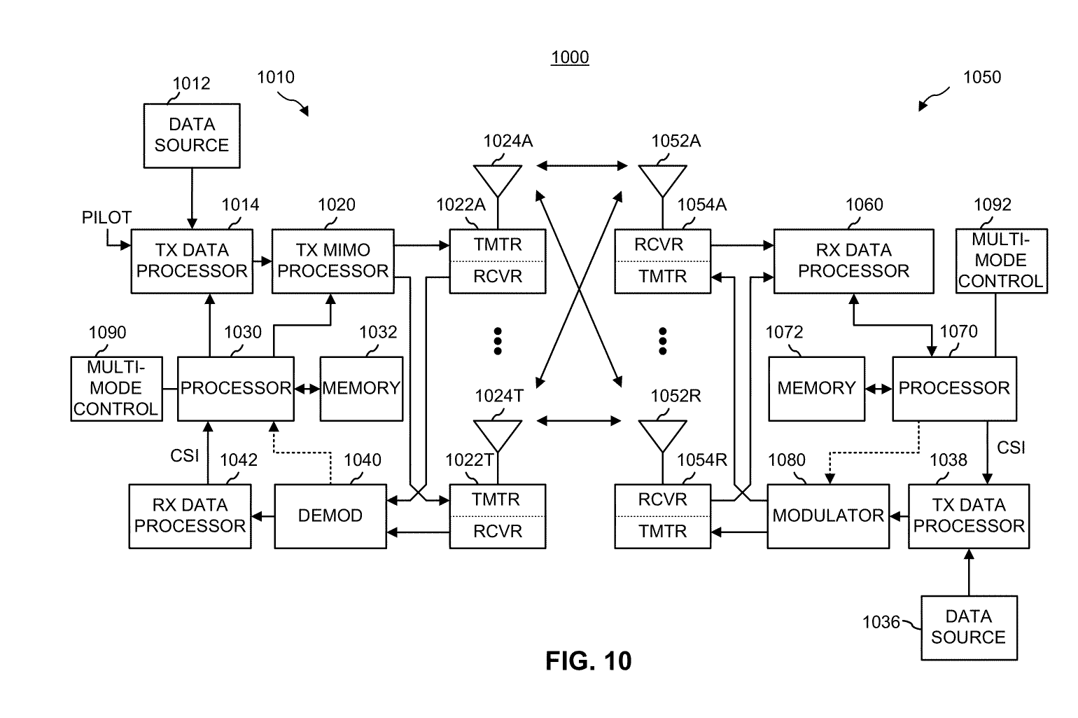

FIG. 10 illustrates a wireless device 1010 (e.g., an access point) and a wireless device 1050 (e.g., an access terminal) of a sample MIMO system 1000. At the device 1010, traffic data for a number of data streams is provided from a data source 1012 to a transmit (TX) data processor 1014. Each data stream may then be transmitted over a respective transmit antenna.

The TX data processor 1014 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1030. A data memory 1032 may store program code, data, and other information used by the processor 1030 or other components of the device 1010.

The modulation symbols for all data streams are then provided to a TX MIMO processor 1020, which may further process the modulation symbols (e.g., for OFDM). The TX MIMO processor 1020 then provides N_{T} modulation symbol streams to N_{T} transceivers (XCVR) 1022A through 1022T. In some aspects, the TX MIMO processor 1020 applies beam-forming weights to the symbols of the data streams and to the antenna from which the symbol is being transmitted.

Each transceiver 1022 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1022A through 1022T are then transmitted from N_{T} antennas 1024A through 1024T, respectively.

At the device 1050, the transmitted modulated signals are received by N_{R} antennas 1052A through 1052R and the received signal from each antenna 1052 is provided to a respective transceiver (XCVR) 1054A through 1054R. Each transceiver 1054 conditions (e.g., filters, amplifies, and downconverts) a respective received signal, digitizes the conditioned signal to provide samples, and further processes the samples to provide a corresponding “received” symbol stream.

A receive (RX) data processor 1060 then receives and processes the N_{R} received symbol streams from N_{R} transceivers 1054 based on a particular receiver processing technique to provide N_{T} “detected” symbol streams. The RX data processor 1060 then demodulates, deinterleaves, and decodes each detected symbol stream to recover the traffic data for the data stream. The processing by the RX data processor 1060 is complementary to that performed by the TX MIMO processor 1020 and the TX data processor 1014 at the device 1010.

A processor 1070 periodically determines which pre-coding matrix to use (discussed below). The processor 1070 formulates a reverse link message comprising a matrix index portion and a rank value portion. A data memory 1072 may store program code, data, and other information used by the processor 1070 or other components of the device 1050.

The reverse link message may comprise various types of information regarding the communication link and/or the received data stream. The reverse link message is then processed by a TX data processor 1038, which also receives traffic data for a number of data streams from a data source 1036, modulated by a modulator 1080, conditioned by the transceivers 1054A through 1054R, and transmitted back to the device 1010.

At the device 1010, the modulated signals from the device 1050 are received by the antennas 1024, conditioned by the transceivers 1022, demodulated by a demodulator (DEMOD) 1040, and processed by a RX data processor 1042 to extract the reverse link message transmitted by the device 1050. The processor 1030 then determines which pre-coding matrix to use for determining the beam-forming weights then processes the extracted message.

FIG. 10 also illustrates that the communication components may include one or more components that perform multi-mode control operations as taught herein. For example, a multi-mode control component 1090 may cooperate with the processor 1030 and/or other components of the device 1010 to allocate access for multiple RATs. Similarly, a multi-mode control component 1092 may cooperate with the processor 1070 and/or other components of the device 1050 to facilitate access allocation. It should be appreciated that for each device 1010 and 1050 the functionality of two or more of the described components may be provided by a single component. For example, a single processing component may provide the functionality of the multi-mode control component 1090 and the processor 1030 and a single processing component may provide the functionality of the multi-mode control component 1092 and the processor 1070. In some aspects, one or more of the components of FIG. 10 (e.g., the multi-mode control and/or processor components) may be implemented by a processing system.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a personal computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femtocell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable RAT. For example, in some aspects a wireless node may associate with a network. In some aspects the network may comprise a local area network or a wide area network. A wireless device may support or otherwise use one or more of a variety of radio access technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other radio access technologies. For example, a wireless node may comprise a wireless transceiver with associated transmitter and receiver components that may include various components (e.g., signal generators and signal processors) that facilitate communication over a wireless medium.

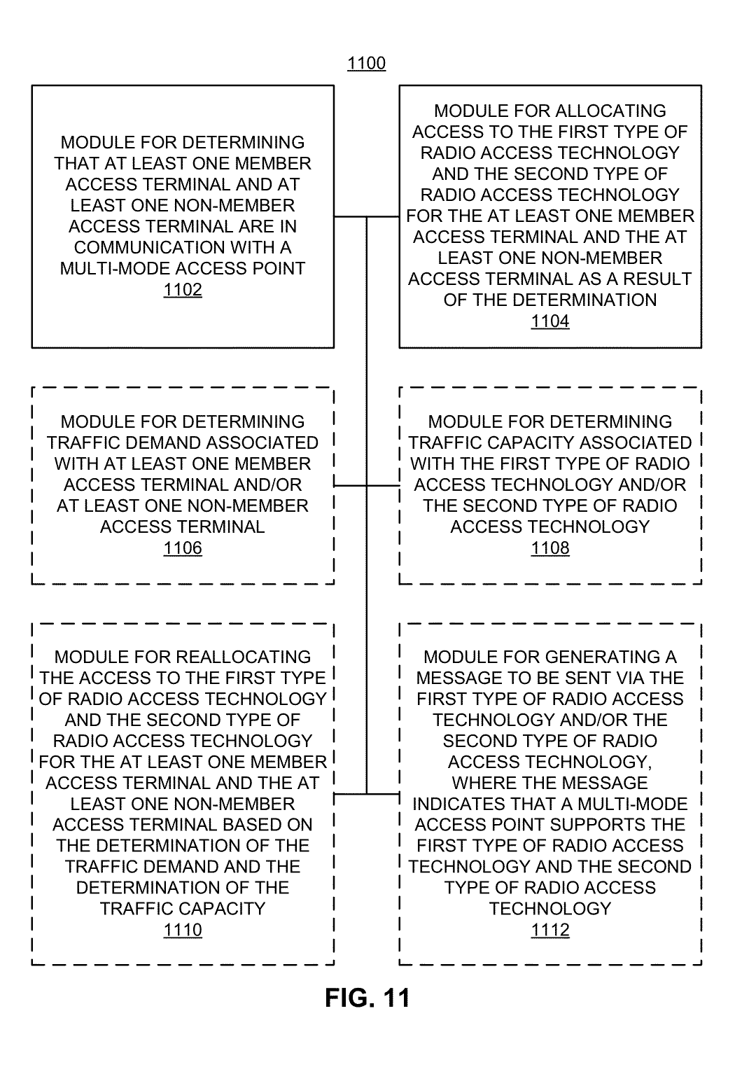

The functionality described herein (e.g., with regard to one or more of the accompanying figures) may correspond in some aspects to similarly designated “means for” functionality in the appended claims. Referring to FIG. 11, an apparatus 1100 is represented as a series of interrelated functional modules. Here, a module for determining that at least one member access terminal and at least one non-member access terminal are in communication with a multi-mode access point 1102 may correspond at least in some aspects to, for example, a processing system and/or a communication device as discussed herein. A module for allocating access to the first type of radio access technology and the second type of radio access technology for the at least one member access terminal and the at least one non-member access terminal as a result of the determination 1104 may correspond at least in some aspects to, for example, a processing system and/or a communication device as discussed herein. A module for determining traffic demand associated with at least one member access terminal and/or at least one non-member access terminal 1106 may correspond at least in some aspects to, for example, a processing system and/or a communication device as discussed herein. A module for determining traffic capacity associated with the first type of radio access technology and/or the second type of radio access technology 1108 may correspond at least in some aspects to, for example, a processing system and/or a communication device as discussed herein. A module for reallocating the access to the first type of radio access technology and the second type of radio access technology for the at least one member access terminal and the at least one non-member access terminal based on the determination of the traffic demand and the determination of the traffic capacity 1110 may correspond at least in some aspects to, for example, a processing system and/or a communication device as discussed herein. A module for generating a message to be sent via the first type of radio access technology and/or the second type of radio access technology, wherein the message indicates that the multi-mode access point supports the first type of radio access technology and the second type of radio access technology 1112 may correspond at least in some aspects to, for example, a processing system and/or a communication device as discussed herein.

The functionality of the modules of FIG. 11 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. The functionality of these modules also may be implemented in some other manner as taught herein. In some aspects one or more of any dashed blocks in FIG. 11 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software (e.g., which may be referred to as software, middleware, firmware, etc., depending on how the codes are deployed), or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for controlling access for a multi-mode access point that supports a first type of radio access technology and a second type of radio access technology, the apparatus comprising a processing system configured to:
determine that at least one member access terminal and at least one non-member access terminal are in communication with the multi-mode access point; and
allocate access to the first type of radio access technology and the second type of radio access technology for the at least one member access terminal and the at least one non-member access terminal as a result of the determination.

2. The apparatus of claim 1, wherein:
the at least one member access terminal belongs to a closed subscriber group associated with the multi-mode access point; and
the at least one non-member access terminal does not belong to any closed subscriber group associated with the multi-mode access point.

3. The apparatus of claim 1, wherein:
the first type of radio access technology comprises wireless wide area network technology; and
the second type of radio access technology comprises Wi-Fi technology.

4. The apparatus of claim 3, wherein the multi-mode access point comprises co-located femtocell and Wi-Fi access points.

5. The apparatus of claim 1, wherein the processing system is further configured to generate an overload indicator for the first type of radio access technology that is transmitted via the second type of radio access technology.

6. The apparatus of claim 1, wherein the processing system is further configured to:
determine traffic demand associated with the at least one member access terminal and/or the at least one non-member access terminal;
determine traffic capacity associated with the first type of radio access technology and/or the second type of radio access technology; and
reallocate the access to the first type of radio access technology and the second type of radio access technology for the at least one member access terminal and the at least one non-member access terminal based on the determination of the traffic demand and the determination of the traffic capacity.

7. The apparatus of claim 1, wherein:
the processing system is further configured to generate a message to be sent via the first type of radio access technology and/or the second type of radio access technology; and
the message indicates that the multi-mode access point supports the first type of radio access technology and the second type of radio access technology.

8. The apparatus of claim 1, wherein the allocation of access gives priority to the at least one member access terminal over the at least one non-member access terminal.

9. The apparatus of claim 1, wherein the multi-mode access point comprises co-located first and second access points that are deployed within a common apparatus or are deployed within separate apparatuses that are located within 2 meters of one another.

10. The apparatus of claim 9, wherein the first access point and the second access point communicate with one another via point-to-point communication.

11. The apparatus of claim 10, wherein the point-to-point communication comprises: inter-process communication, local area network subnet communication, or local bus communication.

12. The apparatus of claim 1, wherein the multi-mode access point comprises radio access technology components for the first type of radio access technology and the second type of radio access technology that are not physically integrated.

13. A method for controlling access for a multi-mode access point that supports a first type of radio access technology and a second type of radio access technology, the method comprising:
determining that at least one member access terminal and at least one non-member access terminal are in communication with the multi-mode access point; and
allocating access to the first type of radio access technology and the second type of radio access technology for the at least one member access terminal and the at least one non-member access terminal as a result of the determination.

14. The method of claim 13, wherein:
the at least one member access terminal belongs to a closed subscriber group associated with the multi-mode access point; and
the at least one non-member access terminal does not belong to any closed subscriber group associated with the multi-mode access point.

15. The method of claim 13, wherein:
the first type of radio access technology comprises wireless wide area network technology; and
the second type of radio access technology comprises Wi-Fi technology.

16. The method of claim 15, wherein the multi-mode access point comprises co-located femtocell and Wi-Fi access points.

17. The method of claim 13, further comprising generating an overload indicator for the first type of radio access technology that is transmitted via the second type of radio access technology.

18. The method of claim 13, further comprising:
determining traffic demand associated with the at least one member access terminal and/or the at least one non-member access terminal;
determining traffic capacity associated with the first type of radio access technology and/or the second type of radio access technology; and
reallocating the access to the first type of radio access technology and the second type of radio access technology for the at least one member access terminal and the at least one non-member access terminal based on the determination of the traffic demand and the determination of the traffic capacity.

19. The method of claim 13, further comprising generating a message to be sent via the first type of radio access technology and/or the second type of radio access technology, wherein the message indicates that the multi-mode access point supports the first type of radio access technology and the second type of radio access technology.

20. The method of claim 13, wherein the allocation of access gives priority to the at least one member access terminal over the at least one non-member access terminal.

21. The method of claim 13, wherein the multi-mode access point comprises co-located first and second access points that are deployed within a common apparatus or are deployed within separate apparatuses that are located within 2 meters of one another.

22. The method of claim 21, wherein the first access point and the second access point communicate with one another via point-to-point communication.

23. The method of claim 22, wherein the point-to-point communication comprises: inter-process communication, local area network subnet communication, or local bus communication.

24. The method of claim 13, wherein the multi-mode access point comprises radio access technology components for the first type of radio access technology and the second type of radio access technology that are not physically integrated.

25. An apparatus for controlling access for a multi-mode access point that supports a first type of radio access technology and a second type of radio access technology, the apparatus comprising:
means for determining that at least one member access terminal and at least one non-member access terminal are in communication with the multi-mode access point; and
means for allocating access to the first type of radio access technology and the second type of radio access technology for the at least one member access terminal and the at least one non-member access terminal as a result of the determination.

26. The apparatus of claim 25, wherein:
the at least one member access terminal belongs to a closed subscriber group associated with the multi-mode access point; and
the at least one non-member access terminal does not belong to any closed subscriber group associated with the multi-mode access point.

27. The apparatus of claim 25, wherein:
the first type of radio access technology comprises wireless wide area network technology; and
the second type of radio access technology comprises Wi-Fi technology.

28. The apparatus of claim 27, wherein the multi-mode access point comprises co-located femtocell and Wi-Fi access points.

29. The apparatus of claim 25, further comprising means for generating an overload indicator for the first type of radio access technology that is transmitted via the second type of radio access technology.

30. The apparatus of claim 25, further comprising:
means for determining traffic demand associated with the at least one member access terminal and/or the at least one non-member access terminal;
means for determining traffic capacity associated with the first type of radio access technology and/or the second type of radio access technology; and
means for reallocating the access to the first type of radio access technology and the second type of radio access technology for the at least one member access terminal and the at least one non-member access terminal based on the determination of the traffic demand and the determination of the traffic capacity.

31. The apparatus of claim 25, further comprising means for generating a message to be sent via the first type of radio access technology and/or the second type of radio access technology, wherein the message indicates that the multi-mode access point supports the first type of radio access technology and the second type of radio access technology.

32. The apparatus of claim 25, wherein the allocation of access gives priority to the at least one member access terminal over the at least one non-member access terminal.

33. The apparatus of claim 25, wherein the multi-mode access point comprises co-located first and second access points that are deployed within a common apparatus or are deployed within separate apparatuses that are located within 2 meters of one another.

34. The apparatus of claim 33, wherein the first access point and the second access point communicate with one another via point-to-point communication.

35. The apparatus of claim 34, wherein the point-to-point communication comprises: inter-process communication, local area network subnet communication, or local bus communication.

36. The apparatus of claim 25, wherein the multi-mode access point comprises radio access technology components for the first type of radio access technology and the second type of radio access technology that are not physically integrated.

37. A computer-program product for controlling access for a multi-mode access point that supports a first type of radio access technology and a second type of radio access technology, the computer-program product comprising:
computer-readable medium comprising code for causing a computer to:
determine that at least one member access terminal and at least one non-member access terminal are in communication with the multi-mode access point; and
allocate access to the first type of radio access technology and the second type of radio access technology for the at least one member access terminal and the at least one non-member access terminal as a result of the determination.

38. The computer-program product of claim 37, wherein:
the at least one member access terminal belongs to a closed subscriber group associated with the multi-mode access point; and
the at least one non-member access terminal does not belong to any closed subscriber group associated with the multi-mode access point.

39. The computer-program product of claim 37, wherein:
the first type of radio access technology comprises wireless wide area network technology; and
the second type of radio access technology comprises Wi-Fi technology.

40. The computer-program product of claim 39, wherein the multi-mode access point comprises co-located femtocell and Wi-Fi access points.

41. The computer-program product of claim 37, wherein the computer-readable medium further comprises code for causing the computer to generate an overload indicator for the first type of radio access technology that is transmitted via the second type of radio access technology.

42. The computer-program product of claim 37, wherein the computer-readable medium further comprises code for causing the computer to:
determine traffic demand associated with the at least one member access terminal and/or the at least one non-member access terminal;
determine traffic capacity associated with the first type of radio access technology and/or the second type of radio access technology; and
reallocate the access to the first type of radio access technology and the second type of radio access technology for the at least one member access terminal and the at least one non-member access terminal based on the determination of the traffic demand and the determination of the traffic capacity.

43. The computer-program product of claim 37, wherein:
the computer-readable medium further comprises code for causing the computer to generate a message to be sent via the first type of radio access technology and/or the second type of radio access technology; and
the message indicates that the multi-mode access point supports the first type of radio access technology and the second type of radio access technology.

44. The computer-program product of claim 37, wherein the allocation of access gives priority to the at least one member access terminal over the at least one non-member access terminal.

45. The computer-program product of claim 37, wherein the multi-mode access point comprises co-located first and second access points that are deployed within a common apparatus or are deployed within separate apparatuses that are located within 2 meters of one another.

46. The computer-program product of claim 45, wherein the first access point and the second access point communicate with one another via point-to-point communication.

47. The computer-program product of claim 46, wherein the point-to-point communication comprises: inter-process communication, local area network subnet communication, or local bus communication.

48. The computer-program product of claim 37, wherein the multi-mode access point comprises radio access technology components for the first type of radio access technology and the second type of radio access technology that are not physically integrated.
